(19) United States
(12) Patent Application Publication
(10) Pub. No.: US 2019/0163463 A1
(43) Pub. Date: May 30, 2019

(54) RELATIONAL PATCH ORCHESTRATION

(71) Applicant: International Business Machines Corporation, Armonk, NY (US)

(72) Inventors: Muhammed Fatih Bulut, New York, NY (US); Lisa M. Chavez, Placitas, NM (US); Jinho Hwang, Ossining, NY (US); Virgina Mayo, Jersey City, NJ (US); Sai Zeng, Yorktown Heights, NY (US)

(21) Appl. No.: 15/826,805

(22) Filed: Nov. 30, 2017

(51) Int. Cl. G06F 9/445

(52) U.S. Cl. CPC G06F 8/65; G06N 99/005

(57) ABSTRACT

Techniques facilitating relational patch orchestration based on impact analysis are provided. In one example, a computer-implemented method comprises creating, by a device operatively coupled to a processor, patch execution plans for one or more pending patches associated with a computing environment; quantifying, by the device, impact of respective ones of the patch execution plans based on dependencies associated with the respective ones of the patch execution plans; and optimizing, by the device, a patch execution plan from the patch execution plans based on the impact of the respective ones of the patch execution plans.

### BACKGROUND

The subject disclosure relates to computing device management, and more specifically, to orchestrating patch implementation within a computing environment.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatus and/or computer program products that facilitate relational patch orchestration.

According to an embodiment, a computer-implemented method can include creating, by a device operatively coupled to a processor, patch execution plans for one or more pending patches associated with a computing environment, quantifying, by the device, impact of respective ones of the patch execution plans based on dependencies associated with the respective ones of the patch execution plans, and optimizing, by the device, a patch execution plan from the patch execution plans based on the impact of the respective ones of the patch execution plans.

According to another embodiment, a system can include a memory that stores computer executable components and a processor that executes computer executable components stored in the memory, where the computer executable components include a planning component that creates patch execution plans for one or more pending patches associated with a computing environment, a scoring component that quantifies impact of respective ones of the patch execution plans based on dependencies associated with the respective ones of the patch execution plans, and a patch orchestration component that selects a patch execution plan from the patch execution plans based on the impact of the respective ones of the patch execution plans.

According to a further embodiment, a computer program product for patch orchestration in a computing environment can include a computer readable storage medium having program instructions embodied therewith. The program instructions can be executable by a processing component to cause the processing component to create patch execution plans for one or more pending patches associated with the computing environment, quantify impact of respective ones of the patch execution plans based on dependencies associated with the respective ones of the patch execution plans, and select a patch execution plan from the patch execution plans based on the impact of the respective ones of the patch execution plans.

According to still another embodiment, a computer-implemented method can include initializing, by a device operatively coupled to a processor, a patch execution plan corresponding to a set of devices and patches in a computing environment, analyzing, by the device, respective candidate actions associated with the set of devices and patches in the computing environment based on impact ratings corresponding to the respective candidate actions, and optimizing, by the device, one or more of the candidate actions for inclusion in the patch execution plan based on a result of the analyzing.

According to an additional embodiment, a system can include a memory that stores computer executable components and a processor that executes computer executable components stored in the memory, where the computer executable components include a discovery component that identifies a set of devices and patches in a computing environment and initializes a corresponding patch execution plan, an impact analysis component that analyzes respective candidate actions for the patch execution plan based on impact ratings corresponding to the respective candidate actions, and an action selection component that selects one or more of the candidate actions for inclusion in the patch execution plan based on a result of the impact analysis component.

### DESCRIPTION OF THE DRAWINGS

FIG. 1 illustrates an example, non-limiting block diagram depicting a cloud computing environment according to one or more embodiments described herein.

FIG. 2 illustrates an example, non-limiting block diagram depicting abstraction model layers according to one or more embodiments described herein.

FIG. 3 is a block diagram of a system that facilitates relational patch orchestration according to one or more embodiments described herein.

FIG. 4 illustrates an example, non-limiting block diagram depicting an example, non-limiting computing generalized process flow for a computing environment in which one or more embodiments described herein can be facilitated.

FIG. 5 is a block diagram of a system that facilitates risk analysis associated with respective patches associated with a computing environment.

FIGS. 6 and 7 are diagrams depicting example, non-limiting relationships between components of a computing environment that can be utilized by one or more embodiments described herein.

FIG. 8 illustrates an example, non-limiting block diagram depicting a system that facilitates patch orchestration and logging according to one or more embodiments described herein.

FIG. 9 is a flow diagram of an example, non-limiting computer-implemented method facilitating patch orchestration in a computing environment according to one or more embodiments described herein.

FIG. 10 is a flow diagram of an example, non-limiting computer-implemented method facilitating graph-based patch orchestration according to one or more embodiments described herein.

FIG. 11 illustrates an example, non-limiting block diagram depicting an example, non-limiting graph structure that can be utilized by one or more embodiments described herein.

FIG. 12 is a block diagram of a system that facilitates relational patch orchestration according to one or more embodiments described herein.

FIG. 13 is a block diagram of a system that facilitates patch orchestration, execution, and logging according to one or more embodiments described herein.

FIGS. 14 and 15 are block diagrams of respective example, non-limiting processing components according to one or more embodiments described herein.

FIG. 16 is a flow diagram of an example, non-limiting computer-implemented method that facilitates relational patch orchestration according to one or more embodiments described herein.

FIG. 17 is a flow diagram of an alternative example, non-limiting computer-implemented method that facilitates relational patch orchestration according to one or more embodiments described herein.

FIG. 18 is a block diagram of an example, non-limiting operating environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Modern computing environment can include a large number of computing devices, which may be located at a single physical site or multiple physical sites, e.g., via a communications network. Devices in a modern computing environment can additionally perform a wide range of tasks via the use of computing applications and related libraries and/or systems. As the versatility of computing devices increases, the number of applications and/or related resources used by such devices similarly increases.

System vulnerabilities associated with a computing environment that are discovered after respective infrastructure components have been released on the market can be repaired through a patching process. Patches can be applied to many different parts of an information system, such as operating systems, servers, routers, desktops, email clients, office suites, mobile devices, firewalls, and many other components that exist within the network infrastructure. However, in a large and/or otherwise complex computing environment, the number of patches to be applied in the environment on a consistent basis can be beyond that which can be reliably handled by a human in a useful or reasonable timeframe.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

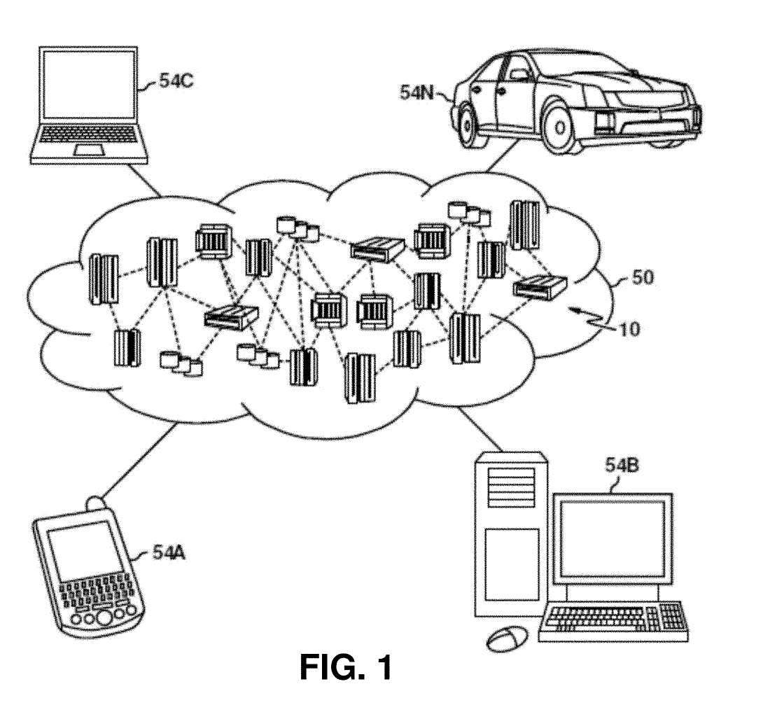

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

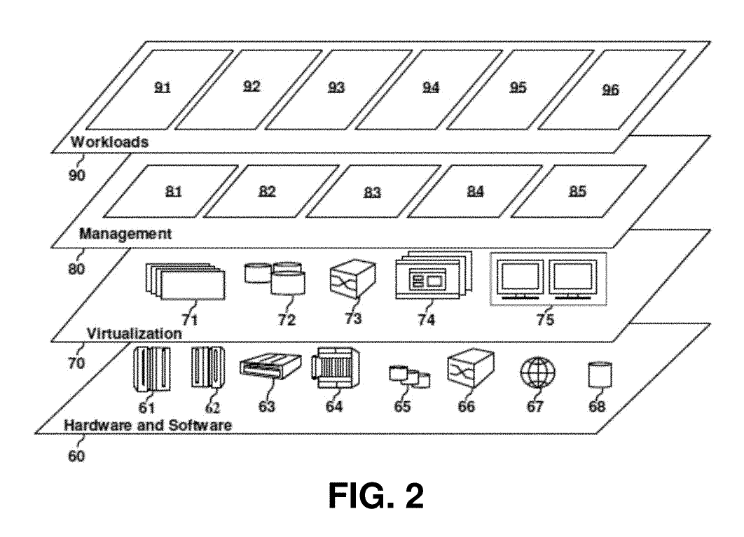

Referring now to FIG. 2, a set of functional abstraction layers provided by cloud computing environment 50 (FIG. 1) is shown. It should be understood in advance that the components, layers, and functions shown in FIG. 2 are intended to be illustrative only and one or more embodiments of the invention are not so limited. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and blockchain management 96.

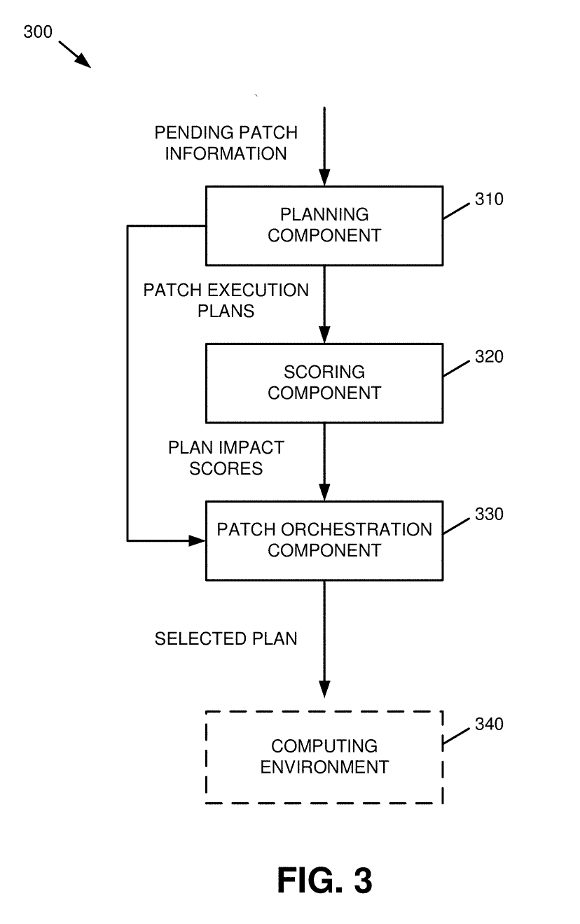

FIG. 3 is a block diagram of a system 300 that facilitates relational patch orchestration according to one or more embodiments described herein. Repetitive description of like elements employed in other embodiments described herein is omitted for sake of brevity. As shown in FIG. 3, the system 300 includes a planning component 310 that creates patch execution plans for one or more pending patches associated with a computing environment 340. The patches can be applied to various software components associated with the computing environment 340, such as operating systems, database frameworks, software libraries, applications, etc. Also or alternatively, patches can be applied to various hardware components such as servers, routers, firewalls, network switches, desktop and/or laptop computers, etc., via firmware, BIOS (basic input/output system) updates, or the like. Patches can be deployed for a variety of uses, such as for repairing system vulnerabilities discovered after respective infrastructure components have been released on the market, improving functionality of existing infrastructure components and/or adding additional functionality, etc.

In an aspect, the planning component 310 can identify patches that are applicable to the computing environment 340 based on factors such as operating systems used by respective computers in the computing environment 340, computing platforms and/or applications utilized in the computing environment 340, or the like. From the identified patches, the planning component 310 can create respective patch execution plans that contain information regarding both the patches to be executed and the sequence in which the patches are to be executed. For instance, different plans can instruct execution of the same or different patches, and can instruct execution of patches in the same or different sequences.

System 300 as shown in FIG. 3 further includes a scoring component 320 that quantifies impact of respective ones of the patch execution plans created by the planning component 310 based on, e.g., dependencies associated with the respective patch execution plans. Dependencies that can be considered by the scoring component 320 in quantifying patch impact can include, but are not limited to, dependencies between respective patches associated with a patch execution plan, dependencies between respective computers in the computing environment 340, dependencies between respective applications in the computing environment, and/or any other suitable relationship between entities and/or components of the computing environment 340.

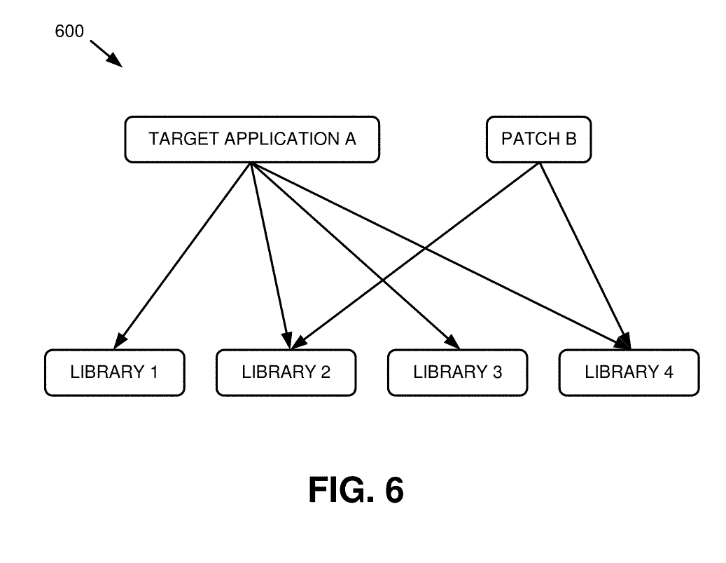

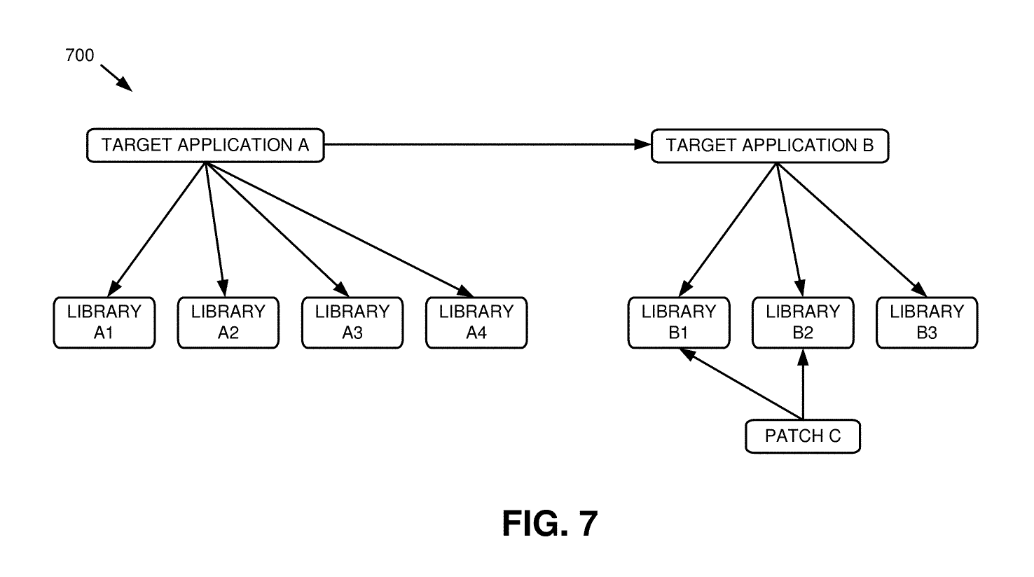

By way of specific, non-limiting example, the computing environment 340 can contain a web server and a database server that provide front-end and back-end functionality for a web application, respectively. In such a case, the web server can depend on the database server since modifications to the database server will affect the web server and any resultant failure of the database server may also result in a failure of the web server. Similar dependencies can exist at other levels of the computing environment 340, e.g., between respective applications, libraries, servers, and/or any suitable components thereof. These and other relationships that can be utilized by the scoring component 320 are described in further detail below with respect to FIGS. 6-7.

In an aspect, the scoring component 320 can assign impact scores and/or other quantified metrics to respective patch execution plans based at least on part of the estimated impact of the respective plans. For instance, in the example of a web server and a database server given above, the scoring component 320 can assign a patch execution plan that patches the web server before the database server a lower impact score than a plan that does the opposite, as the former would result in reduced overall system downtime in the event that one of the patches fails.

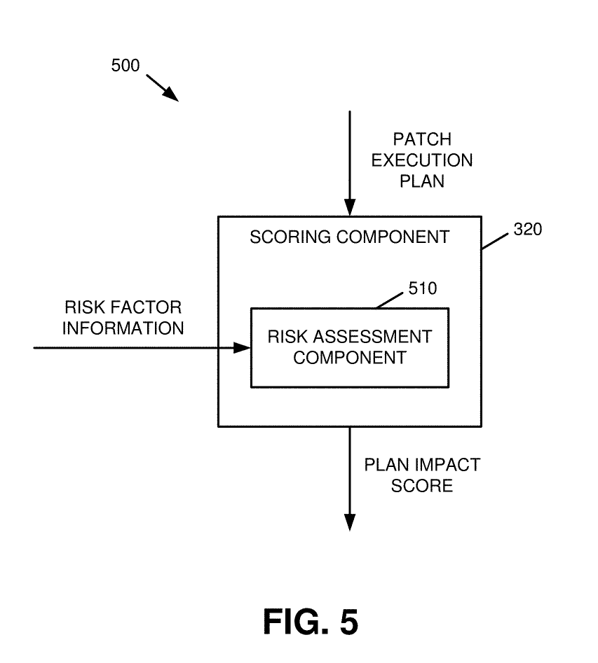

In another aspect, an impact score assigned by the scoring component 320 can be further based on various risk parameters associated with the patch execution plans and/or the computing environment 340, e.g., risk of downtime or other performance loss in the event of a patch failure, risk to security of the computing environment 340 in the event that a patch is not timely applied, and so on. Risk assessment and its role in estimating impact of patch execution plans is described in further detail below with respect to FIG. 5.

As further shown by FIG. 3, system 300 includes a patch orchestration component 330 that selects a patch execution plan from the patch execution plans created by the planning component 310 and scored by the scoring component 320 based on the impact of the respective ones of the patch execution plans.

In an aspect, the patch orchestration selects a patch execution plan created by the planning component 310 that has a lowest impact score as assigned by the scoring component 320, thereby facilitating execution of a patch execution plan having a minimal impact on the computing environment 340. Other selection criteria could also be used. For instance, the patch orchestration component 330 can select a patch execution plan from among a set of patch execution plans that have impact scores below a threshold, e.g., via random selection and/or based on other predefined criteria. Other factors could also affect selection of a patch execution plan as performed by the patch orchestration component 330, such as user preferences, a history of previous patches performed in the computing environment 340 and their respective results, etc.

In an aspect, orchestrated patching as facilitated via system 300 can provide minimal impact while patching servers and/or other computers in an orchestrated fashion, thereby improving the performance of a computing environment 340 and its respective computers. Patching as performed in the manner described herein can also prevent data system failures, which can ultimately prevent revenue loss. Further, for large data centers and/or other computing environments with a large number of machines, applications and/or libraries, the amount of patches that are issued for a single computing environment can be beyond that which can be reasonably recognized and/or maintained by a human operator in a reasonable or useful timeframe. As a result, patches issued for a computing environment can often be missed or delayed, which can in turn cause vulnerabilities in the systems used and/or otherwise reduce performance. The system 300, in contrast, can orchestrate and automatically execute large sets of patches using predictive impact assessment, enabling the computing environment to be maintained in a continuous or near-continuous manner while also eliminating the potential for human error in the patching process. In an aspect, users can be given opportunities to provide feedback and/or direction in the automated patching process, thereby enabling users to conduct risk-aware cognitive patching based on, e.g., the assigned index scores.

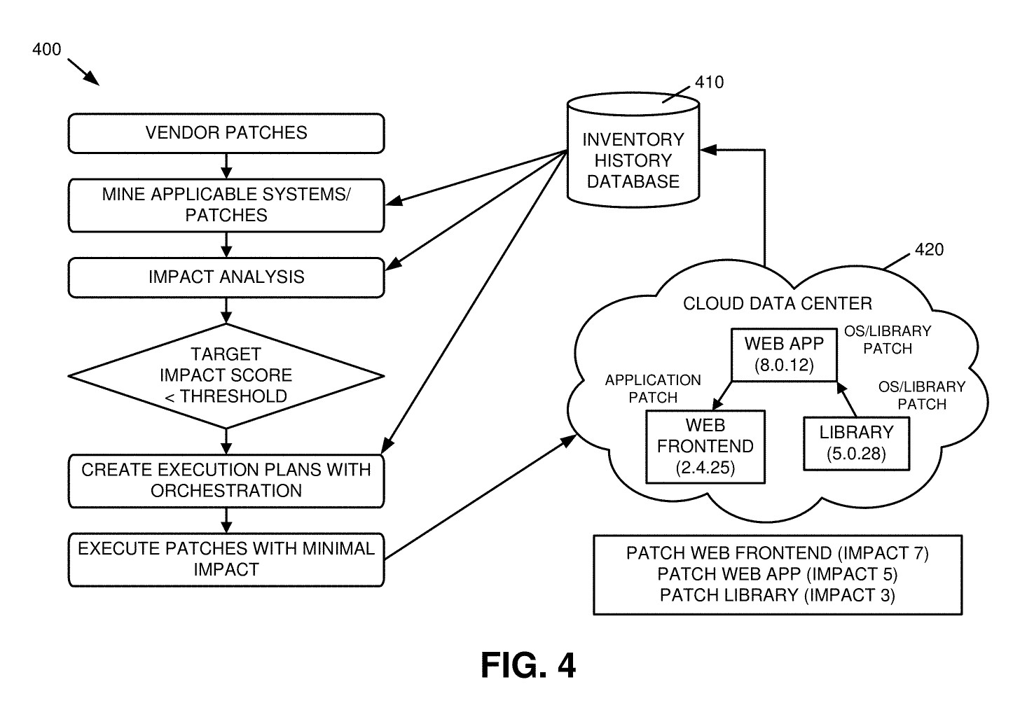

Turning next to FIG. 4, shown illustrates an example, non-limiting block diagram 400 depicting an example, non-limiting generalized process flow for a computing environment in which one or more embodiments described herein can be facilitated. Repetitive description of like elements employed in other embodiments described herein is omitted for sake of brevity. As shown in FIG. 4, a set of vendor patches can be monitored in relation to a computing environment. The set of vendor patches can be, e.g., generalized sets of patches published by one or more hardware and/or software vendors having components that are deployed in the computing environment.

In an aspect, vendor patch information received from a given vendor can include information relating to patches for components that are deployed in the computing environment as well as components associated with the vendor that are not deployed in the computing environment. Accordingly, as further shown in FIG. 4, the vendor patch information can be analyzed to identify patches indicated in the patch information that are relevant to the computing environment.

In an aspect, the vendor patch information can be compared to information stored at an inventory history database 410 corresponding to the computing environment. The inventory history database 410 stores information relating to various hardware and/or software components in the environment. Also or alternatively, the inventory history database 410 can store information relating to operational history (e.g., patch logs, error logs, etc.) of respective components of the computing environment. The inventory history database 410 can be maintained automatically, e.g., as part of a data center inventory management system and/or cloud management platform, or alternatively some or all of the inventory history database 410 can be maintained manually. While the inventory history database 410 is illustrated as a database structure, it should be appreciated that information pertaining to the computing environment can be stored in any suitable manner in any suitable data structure, e.g., a database, a linked list, a tree, etc.

In response to mining applicable systems and/or patches, the impact of respective systems and/or patches can be analyzed. In an aspect, this analysis can be conducted based on the respective patches to be applied and dependencies between respective components in the environment. By way of example, FIG. 4 illustrates a cloud data center 420 that executes a web application that utilizes a library, a web application, and a web frontend. The arrows between the components of the cloud data center 420 represent dependencies between the respective components. In this example, the dependencies between the components of the cloud data center 420, and/or other suitable criteria, can be used to calculate impact scores for respective patches to be applied, as illustrated below the cloud data center 420.

In an aspect, the above analysis results in a target impact score associated with the computing environment. If this target impact score is below a given threshold, patch execution is initiated by creating patch execution plans with orchestration and impact optimization. To minimize patch impact for a given patch execution, impact score-based actions can be recommended. The recommended actions can then be performed, and the impacts of those actions can be monitored and stored, e.g., in the inventory history database 410.

Turning now to FIG. 5, shown is a block diagram of a system 500 that facilitates risk analysis associated with respective patches associated with a computing environment, e.g., the computing environment 340. Repetitive description of like elements employed in other embodiments described herein is omitted for sake of brevity. As shown in system 500, respective patch execution plans, e.g., patch execution plans created by the planning component 310, can be provided to the scoring component 320. In an aspect, the scoring component 320 includes a risk assessment component 510 that determines respective risk factors associated with respective ones of the one or more pending patches, e.g., based on risk factor information provided to the scoring component 320 and/or determined by the risk assessment component 510 based on the patch execution plans themselves, properties of the associated computing environment, and/or other information.

The risk assessment component 510 can assign plan impact scores to respective ones of the patch execution plans that are indicative of the risk factors associated with the respective patch execution plans. As a result, the patch orchestration component 330, and/or the scoring component 320, can select an appropriate patch execution plan based on the respective risk factors associated therewith.

In an aspect, the risk assessment component 510 can assign impact scores to respective patch execution plans based at least in part on relationships between patches and/or components of the computing environment that would be affected by the respective patch execution plans. In one example, relationships between elements of the computing environment can be determined based on a traceability analysis. In a traceability analysis, links between requirements, specifications, and design elements can be found and analyzed to determine the scope of an initiating change.

An example traceability analysis is shown by diagram 600 in FIG. 6. Here, a target application A can be traced to each of libraries 1-4, while a patch B can be traced to libraries 2 and 4. Because patch B impacts libraries that are utilized by application A, patch B can be designated as impacting application A even though patch B does not modify application A directly.

In another example, relationships between elements of the computing environment can be determined based on a dependency analysis. In a dependency analysis, dependencies can be defined by linkages between parts, logic, modules, and/or other elements of a computing environment. These linkages can then be assessed to determine the consequences of an initiating change. In this manner, dependency can be conceptualized at a broader level than traceability, where traceability is a subset of dependency. For instance, within a system design, network traces can be run to identify dependencies.

An example dependency analysis is shown by diagram 700 in FIG. 7. Here, a first target application A utilizes libraries A1-A4 and can be traced to a second target application B. The target application B, in turn, utilizes libraries B1-B3, which can be the same or different from respective ones of libraries A1-A4. Further, a patch C can be traced to libraries B1 and B2. Because patch C impacts libraries that are utilized by target application B, patch C can be designated as impacting target application B via traceability as described above. In addition, because target application A depends on target application B, target application B can be designated as impacting target application A. As a result, patch C can also be designated as impacting target application A via the dependency between target applications A and B.

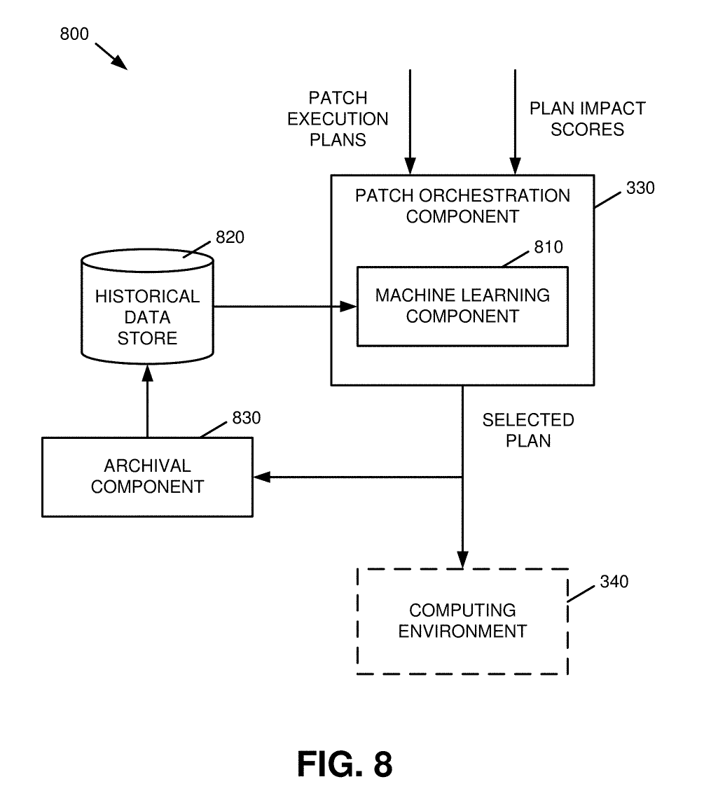

Referring now to FIG. 8, shown illustrates an example, non-limiting block diagram depicting a system 800 that facilitates patch orchestration and logging according to one or more embodiments described herein. Repetitive description of like elements employed in other embodiments described herein is omitted for sake of brevity. In an aspect, system 800 includes a patch orchestration component 330, which receives patch execution plans (e.g., from a planning component 310) and corresponding plan impact scores (e.g., from a scoring component 320) relating to one or more elements of a computing environment 340. As further shown in system 800, the patch orchestration component 330 includes a machine learning component 810. In an aspect, the machine learning component 810 can select a patch execution plan, e.g., from among patch execution plans obtained from the planning component 310, based on historical data associated with at least one of the computing environment 340 or respective ones of a set of pending patches.

In an aspect, historical data utilized by the machine learning component 810 can be stored by and/or otherwise accessed from a historical data store 820. The historical data store can be a database, linked list, tree structure, and/or any other suitable data structure that maintains data relating to previously executed patches, impact ratings corresponding to previously executed patches, and/or other information associated with the computing environment 340 and/or its operation. Using data from the historical data store 820, the machine learning component 810 can estimate impacts for respective patch execution plans using respective impact ratings given by the historical data store 820 corresponding to respective previously executed patches.

In another aspect, the patch orchestration component 330 can execute a patch execution plan chosen by the machine learning component 810 for the computing environment 340. Additionally, the patch orchestration component can provide information regarding the computing environment 340 and/or the selected patch execution plan to an archival component 830. The archival component 830 can store, via the historical data store 820, identities of respective patches associated with a selected patch execution plan, e.g., a patch execution plan selected and/or carried out by the patch orchestration component 330. Also or alternatively, the archival component 830 can store, via the historical data store 820, impact ratings associated with respective patches, results of executing respective patches, and/or other suitable historical information.

In a further aspect, the archival component 830 and historical data store 820 can be utilized to facilitate experiential impact analysis for the computing environment. As an example, the historical data store 820 can store data relating to the computing environment 340 shown in FIG. 8 as well as one or more additional computing environments, which may or may not be maintained by system 800. In this way, the patch orchestration component 330 can leverage similarities exhibited by data center platforms in different environments. For instance, one patch in one environment (e.g., testing) can have a similar consequence in another environment (e.g., production). Likewise, different data centers can also share experiences. For instance, an information technology (IT) management system can capture patch execution in a first data center and apply that information in a different data center.

As described above, the machine learning component 810 can additionally facilitate an active learning methodology that enables the capture of patching experience (e.g., patterns) in respective upgrades and their corresponding impact. This can include monitoring and capturing real-time or near-real-time data. Also or alternatively, this can enable a user to provide feedback in a structured way, which can then be consumed via automation.

In an aspect, the machine learning component 810 can be utilized to proactively recommend continuous patching for a computing environment 340 based on, e.g., history, similar patterns in the computing environment 340 and/or other environments, available software updates, available patches and/or bug fixes, software and/or operating system versions associated with the computing environment 340, communication protocols utilized by the computing environment 340, or the like. In one example, the machine learning component 810 can operate as part of a cloud management system that provides continuous or near-continuous security patching.

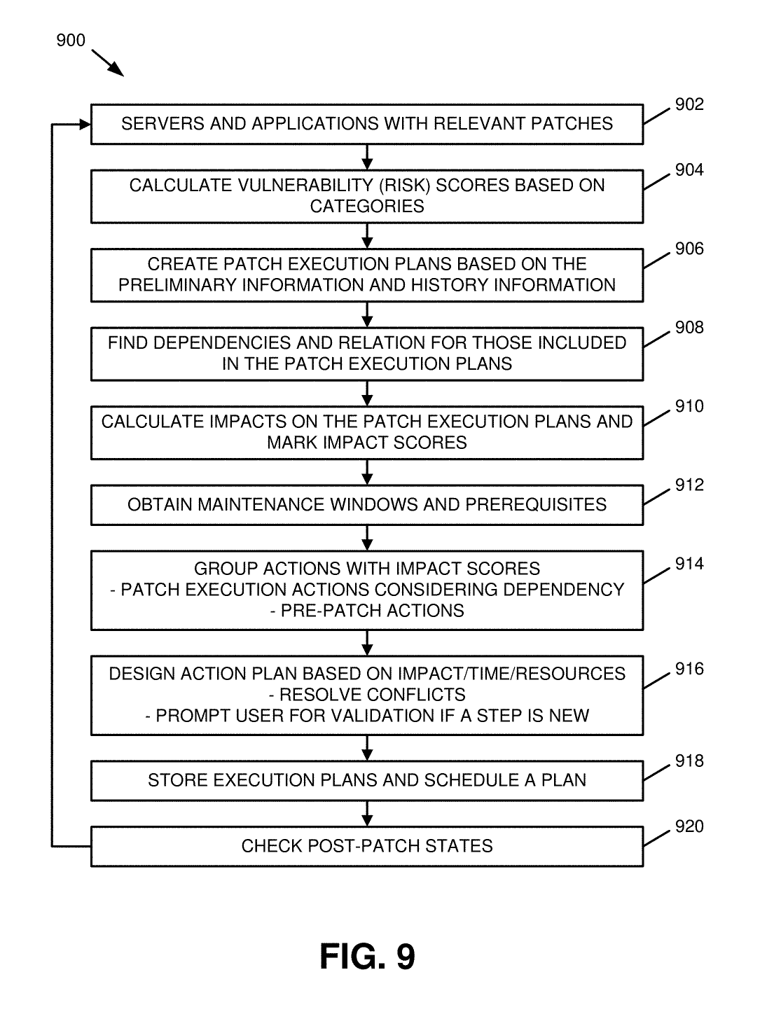

FIG. 9 illustrates a flow diagram of an example, non-limiting computer-implemented method 900 that facilitates patch orchestration in a computing environment in accordance with one or more embodiments described herein. Repetitive description of like elements employed in other embodiments described herein is omitted for sake of brevity. While not explicitly shown in FIG. 9, it should be appreciated that, where applicable, each act of method 900 can be performed by a computing device operatively coupled to a processor.

At 902, servers and applications with relevant patches can be discovered (e.g., by a planning component 310). In one example, discovery can occur at 902 by performing relevance checks on respective servers, applications, and/or other elements in a computing environment 340 having patches.

At 904, vulnerability (risk, impact, etc.) scores can be calculated (e.g., by a risk assessment component 510) based on respective categories. In one example, vulnerability scores can be assigned to respective categories according to a numerical scale, e.g., a 0-10 scale or the like.

At 906, patch execution plans can be created (e.g., by the planning component 310) based on the preliminary information obtained at 902-904 and history information. History information can be obtained via, e.g., an inventory history database 410 as shown in FIG. 4 and/or a historical data store 820 as shown in FIG. 8. In an aspect, history for applied patches can be stored, and learning components, such as the machine learning component 810, can store model parameters to calculate impacts based at least in part on the history.

At 908, dependencies and relations can be found (e.g., by the planning component 310 and/or the scoring component 320) for patches included in the patch execution plans. This information can be found based on, e.g., subject matter expert (SME) input, similar configuration schemas, latest software updates, latest patches and/or bug fixes, and/or any other suitable source(s) of information.

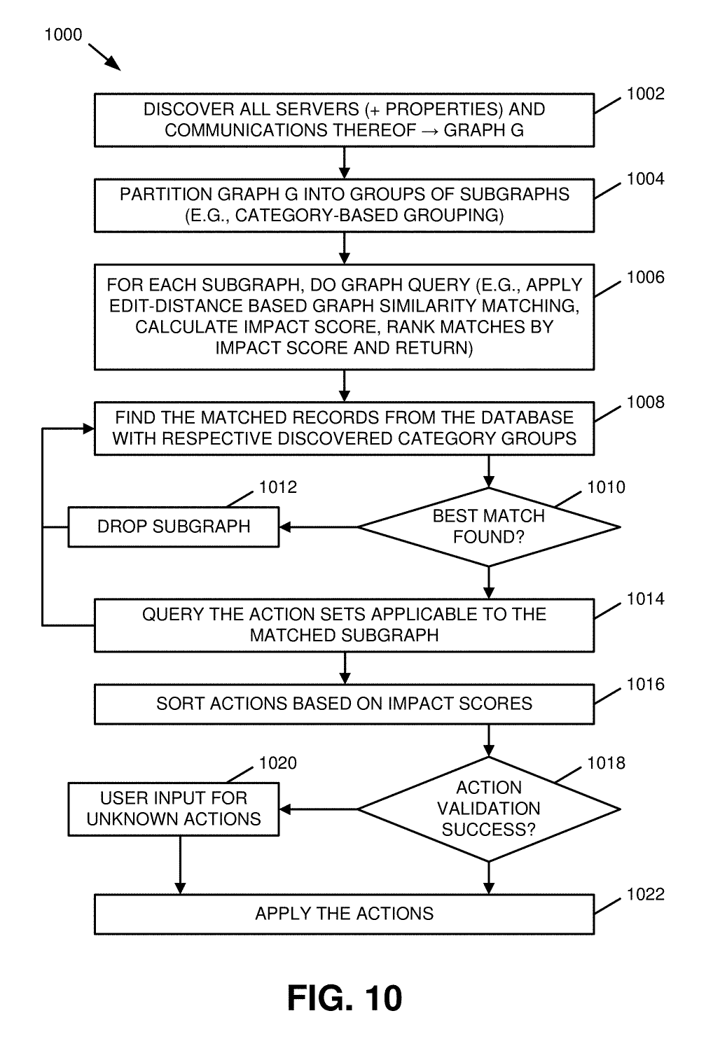

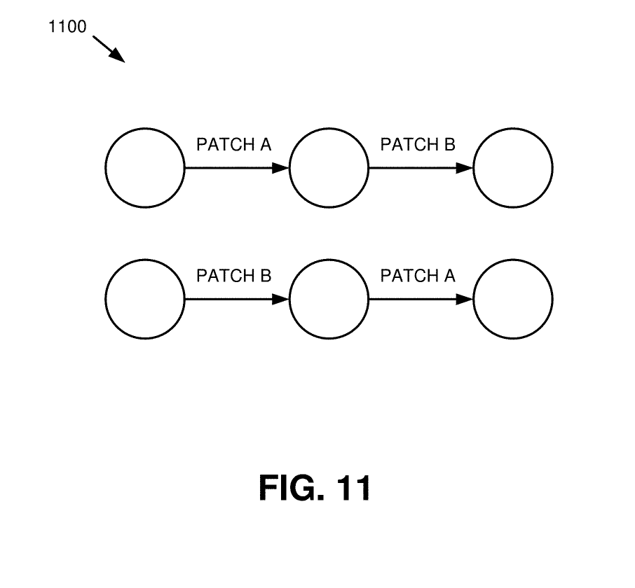

At 910, impacts on the respective patch execution plans can be calculated (e.g., by the scoring component 320), and corresponding impact scores can be recorded. In an aspect, impacts can be calculated using graph-based impact discovery as described below with respect to FIGS. 10-11.

At 912, maintenance windows, e.g., predefined maintenance windows, and prerequisite requirements for the respective patch execution plans can be obtained (e.g., by a patch orchestration component 330).

At 914, actions can be grouped (e.g., by the patch orchestration component 330) with their corresponding impact scores. Here, patch execution actions can be grouped considering their dependency, e.g., sequential patch execution actions can be aligned. Also or alternatively, pre-patch actions, such as downloading packages, can be identified.

At 916, a plan of actions can be designed (e.g., by the patch orchestration component 330) based on impact, time, resources, and/or other considerations. In an aspect, sub-actions can be created for respective actions at this stage. Additionally, any conflicts while patching can be identified and resolved, e.g., by checking dependencies. In another aspect, if a step corresponding to the action plan is new (e.g., the step has not previously been performed at a corresponding computing environment), a user can be prompted for validation of the action.

At 918, execution plans can be stored and scheduled (e.g., by the patch orchestration component 330). Here, a plan can be stored along with its associated time, cost and/or resource parameters. Upon being scheduled, the plan can be executed according to the schedule and/or saved for future repetition.

At 920, post-patch states of the computing environment can be checked (e.g., by an archival component 830) subsequent to execution of the action plan. These states can be recorded, e.g., in an inventory history database 410 as shown in FIG. 4 and/or a historical data store 820 as shown in FIG. 8. Following the actions taken at 920, the method 900 can return to 902 for further patching.

With reference next to FIG. 10, shown is a flow diagram of an example, non-limiting computer-implemented method 1000 that facilitates graph-based patch orchestration in accordance with one or more embodiments described herein. Repetitive description of like elements employed in other embodiments described herein is omitted for sake of brevity. While not explicitly shown in FIG. 10, it should be appreciated that, where applicable, each act of method 1000 can be performed by a computing device operatively coupled to a processor.

At 1002, respective servers in a computing environment and their corresponding properties, along with communicative associations between those servers, can be discovered (e.g., by a planning component 310), and a graph G can be constructed using this information. At 1004, the graph G is partitioned (e.g., by the planning component 310) into groups of subgraphs based on, e.g., category-based grouping.

At 1006, a graph query can be conducted (e.g., by a scoring component 320) for each subgraph created at 1004. For instance, edit-distance based graph similarity matching can be applied, impact scores can be calculated as described above, and matches can be ranked by their impact scores and returned.

At 1008, respective records of an inventory database, e.g., an inventory history database 410 as shown in FIG. 4, that match respective ones of the discovered category groups can be found (e.g., by the planning component 310 and/or the scoring component 320). At 1010, it can be determined (e.g., by the scoring component 320) if a matching subgraph found at 1008 is a best match, e.g., a subgraph that minimizes I (X, T)=∥ (X−Tᵢ)/σᵢ∥ constrained to σᵢϵ[0, 1], where I is the impact score of the template, n is the number of templates, and σ is a weighting coefficient. If a subgraph analyzed at 1010 is determined to not be a best match, the subgraph can be dropped at 1012 (e.g., by the planning component 310 and/or the scoring component 320). Otherwise, the method 1000 can proceed to 1014.

At 1014, the action sets applicable to the subgraph matched at 1010 can be queried (e.g., by the scoring component 320). At 1016, the actions in these action sets can be sorted based on their impact scores (e.g., by the scoring component 320 and/or a patch orchestration component 330).

Following the sorting at 1016, respective actions can be executed (e.g., by the patch orchestration component 330). At 1018, an executed action can be validated (e.g., by the patch orchestration component 330). If validation is unsuccessful, the method 1000 proceeds to 1020, where user input can be provided for unknown actions. Upon successful validation at 1018, or upon receipt of user input at 1020 for non-validated actions, the actions can be applied at 1022 (e.g., by the patch orchestration component 330).

Diagram 1100 in FIG. 11 illustrates example graph structures that can be utilized in connection with impact evaluation and execution, e.g., as described above with respect to FIG. 10. Initially, all edges of the graph structure can be set to a default impact rating. Next, a set A can be defined to include action edges from the graph structure that are associated with the application/server pattern of the computing environment. For each action in A, a history H of executed patches and their individual impact ratings can be searched. Based on this search, a set of relevant actions with a sufficiently small impact (e.g., a failure rate lower than a threshold) can be identified. In the non-limiting example shown by diagram 1100, a set of actions corresponding to the respective subgraphs with a highest patch level and/or minimal impact can be selected.

Following the above analysis, the resulting list of actions can be returned and executed, and failures and/or successes associated with the execution of the respective actions can be monitored and logged. The action outcomes can then be stored as historical data, and the impact ratings for respective actions can be adjusted accordingly. If an action and/or outcome is uncertain, an SME can be engaged to rate the impact.

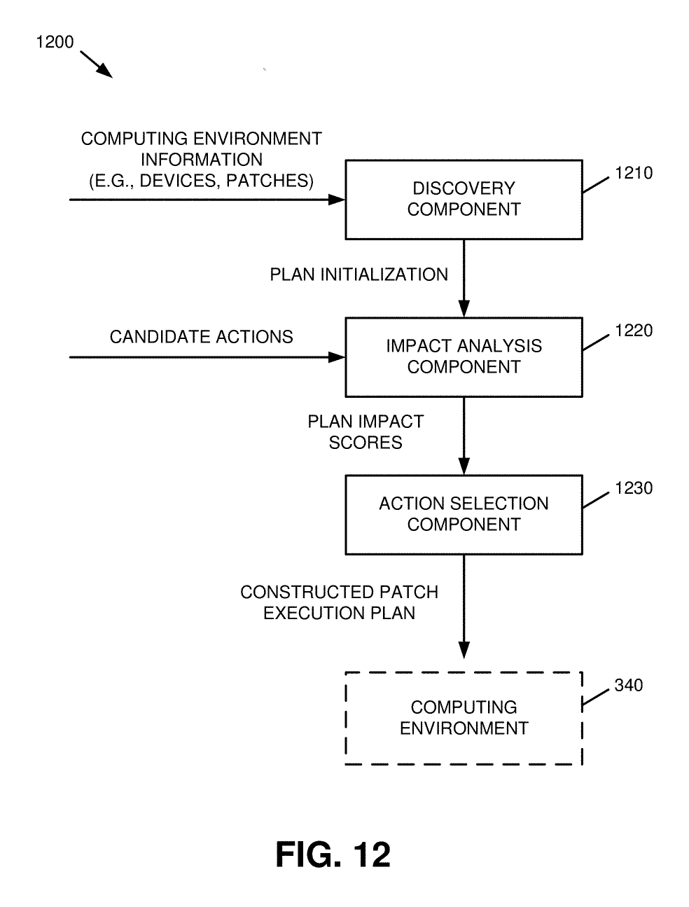

With reference next to FIG. 12, shown is a block diagram of a system 1200 that facilitates relational patch orchestration according to one or more embodiments described herein. Repetitive description of like elements employed in other embodiments described herein is omitted for sake of brevity. The system 1200 includes a discovery component 1210 that can identify a set of devices and patches in a computing environment 340, e.g., on the basis of information regarding the computing environment provided to the discovery component 1210 via, e.g., an inventory history database 410 as shown in FIG. 4, and initialize a corresponding patch execution plan.

The system 1200 further includes an impact analysis component 1220 that can analyze respective candidate actions for the patch execution plan as initialized by the discovery component 1210 based on impact ratings corresponding to the respective candidate actions. In an aspect, the impact analysis component 1220 can determine the impact ratings for respective candidate actions on the basis of dependencies between elements of the computing environment, e.g., as described above with respect to FIGS. 6-7.

Additionally, the system 1200 includes an action selection component that selects one or more of the candidate actions evaluated by the action selection component 1230 based on a result of the impact analysis component 1220, e.g., impact scores and/or other metrics associated with the respective candidate actions by the impact analysis component 1220. In one example, the action selection component 1230 can select for execution a set of candidate actions having a minimal combined impact as determined by the respective impact ratings. Other metrics could also be used. For instance, the action selection component 1230 can select a set of actions having a total impact that is less than a threshold.

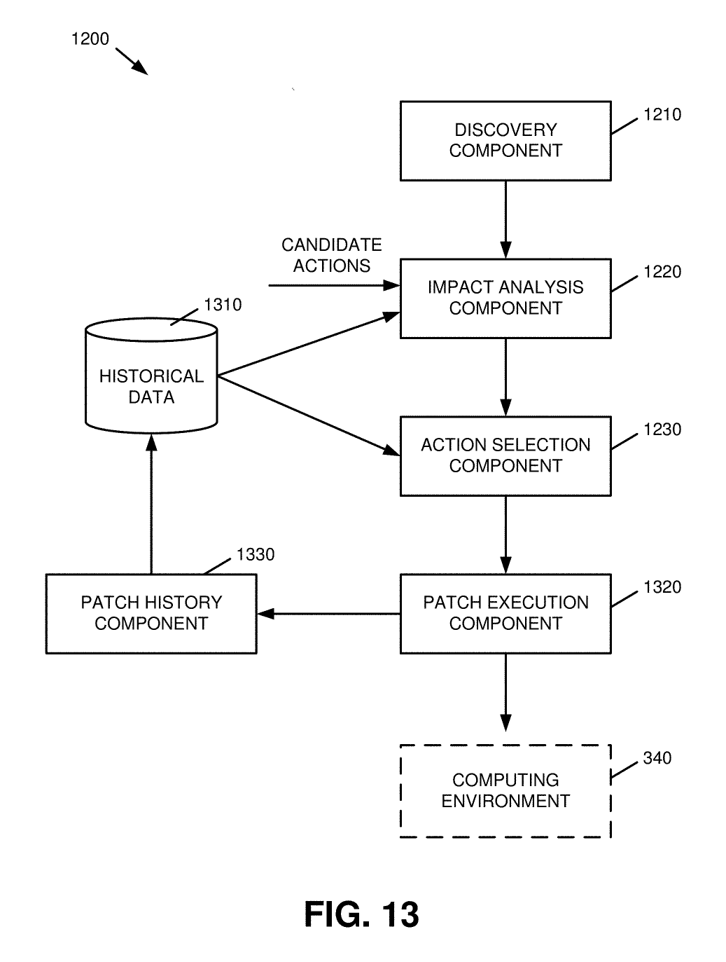

Turning to FIG. 13, shown is a block diagram of a system 1300 that facilitates patch orchestration, execution, and logging according to one or more embodiments described herein. Repetitive description of like elements employed in other embodiments described herein is omitted for sake of brevity. The system 1300 includes a discovery component 1210, impact analysis component 1220, and action selection component 1230 that can function as described above with respect to FIG. 12.

As shown by system 1300, the impact analysis component can analyze respective candidate actions based on historical data 1310 associated with the computing environment and/or the set of devices and patches in the computing environment 340 identified by the discovery component 1210.

In an aspect, system 1300 further includes a patch execution component 1320 that can execute respective actions selected by the action selection component 1230 for inclusion in the patch execution plan. The executed actions, and/or their corresponding outcomes, can be recorded by a patch history component 1330, e.g., as part of the historical data 1310.

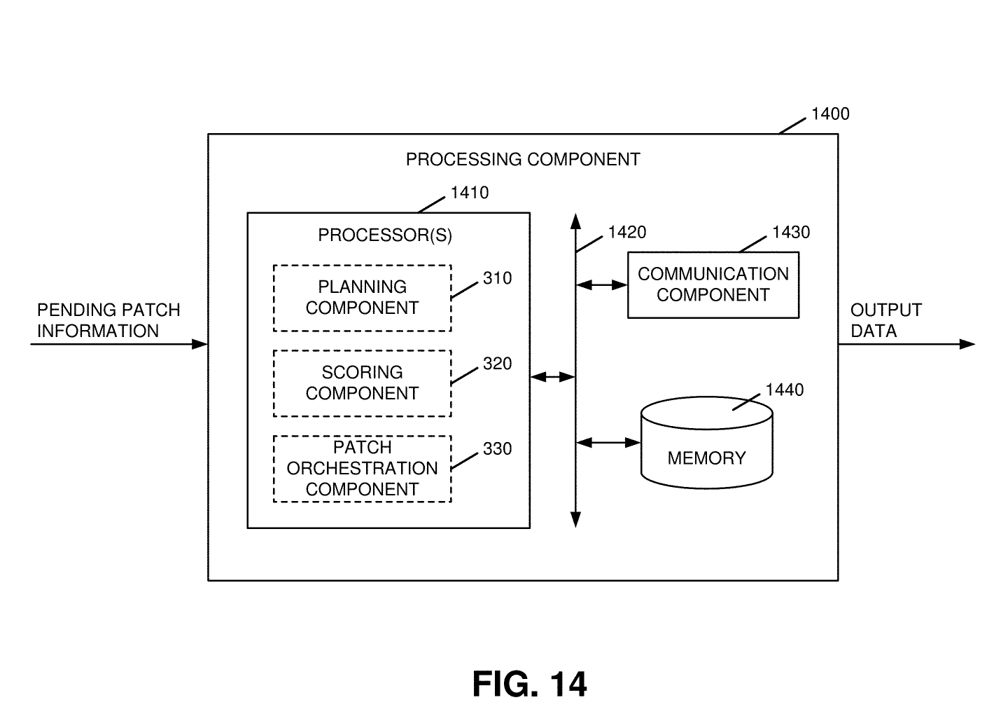

Referring next to FIG. 14, a processing component 1400 that can be utilized to implement one or more aspects described herein is illustrated in accordance with one or more embodiments. Repetitive description of like elements employed in other embodiments described herein is omitted for sake of brevity.

As shown in FIG. 14, the processing component 1400 can be associated with at least one processor 1410 (e.g., a central processing unit, a graphical processing unit, etc.), which can be utilized to implement one or more of the planning component 310, scoring component 320, and/or patch orchestration component 330 as described above. The processor(s) 1410 can be connected via a data bus 1420 to one or more additional sub-components of the processing component 1400, such as a communication component 1430 and/or a memory 1440. While the communication component 1430 is illustrated as implemented separately from the processor(s) 1410, the processor(s) 1410 in some embodiments can additionally be used to implement the communication component 1430. In still other embodiments, the communication component 1430 can be external to the processing component 1400 and communicate with the processing component 1400 via a separate communication link.

The memory 1440 can be utilized by the processing component 1400 to store data utilized by the processing component 1400 in accordance with one or more embodiments described herein. Additionally or alternatively, the memory 1440 can have stored thereon machine-readable instructions that, when executed by the processing component 1400, cause the processing component (and/or one or more processors 1410 thereof) to implement the planning component 310, scoring component 320, and/or patch orchestration component 330 as described above.

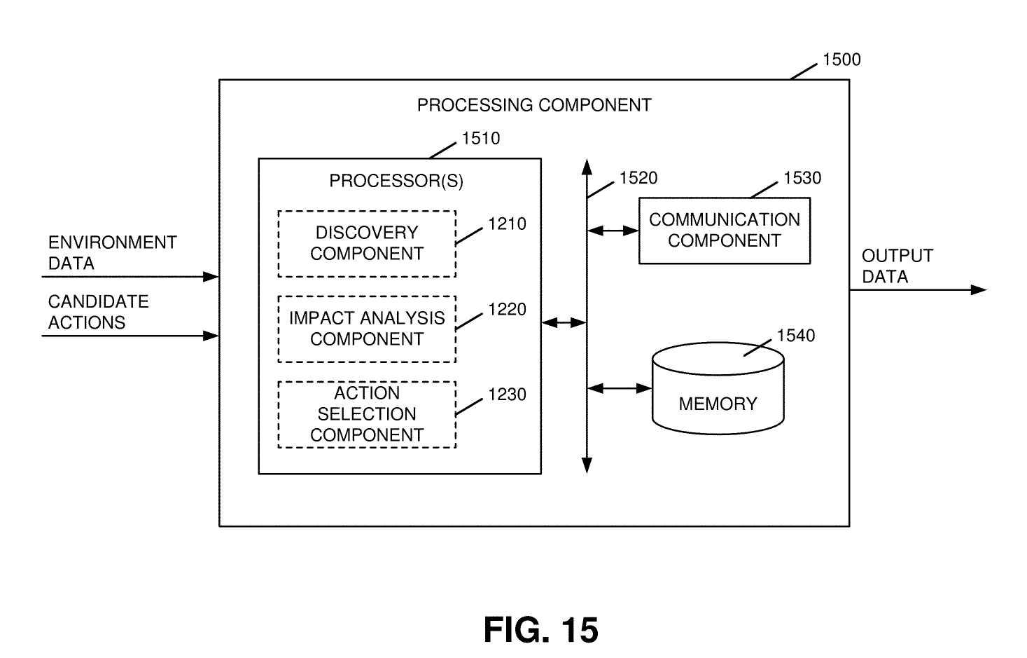

FIG. 15 illustrates another processing component 1500 that can be utilized to implement one or more aspects described herein is illustrated in accordance with one or more embodiments. Repetitive description of like elements employed in other embodiments described herein is omitted for sake of brevity.

As shown in FIG. 15, the processing component 1500 can be associated with at least one processor 1510, which can be utilized to implement one or more of the discovery component 1210, impact analysis component 1220, and/or action selection component 1230 as described above. The processor(s) 1510 can be connected via a data bus 1520 to one or more additional sub-components of the processing component 1500, such as a communication component 1530 and/or a memory 1540. In an aspect, the communication component 1530 can be configured in similar manners to the communication component 1430 described above with respect to FIG. 14.

Similar to the memory 1440 described above with respect to FIG. 14, the memory 1540 can be utilized by the processing component 1500 to store data utilized by the processing component 1500 in accordance with one or more embodiments described herein. Additionally or alternatively, the memory 1540 can have stored thereon machine-readable instructions that, when executed by the processing component 1500, cause the processing component (and/or one or more processors 1510 thereof) to implement the discovery component 1210, impact analysis component 1220, and/or action selection component 1230 as described above.

In various embodiments, the processing components 1400, 1500 shown in FIGS. 14-15 can be or include hardware, software (e.g., a set of threads, a set of processes, software in execution, etc.) or a combination of hardware and software that performs a computing task (e.g., a computing task associated with received data). For example, processing components 1400, 1500 can execute graph analysis and/or operations that cannot be performed by a human (e.g., are greater than the capability of a human mind). For example, the amount of data processed, the speed of processing of the data and/or the data types processed by processing components 1400, 1500 over a certain period of time can be respectively greater, faster and different than the amount, speed and data type that can be processed by a single human mind over the same period of time. For example, data processed by processing components 1400, 1500 can be raw data (e.g., raw textual data, raw numerical data, etc.) and/or compressed data (e.g., compressed textual data, compressed numerical data, etc.) associated with one or more computing devices. Moreover, processing components 1400, 1500 can be fully operational towards performing one or more other functions (e.g., fully powered on, fully executed, etc.) while also processing the above-referenced data.

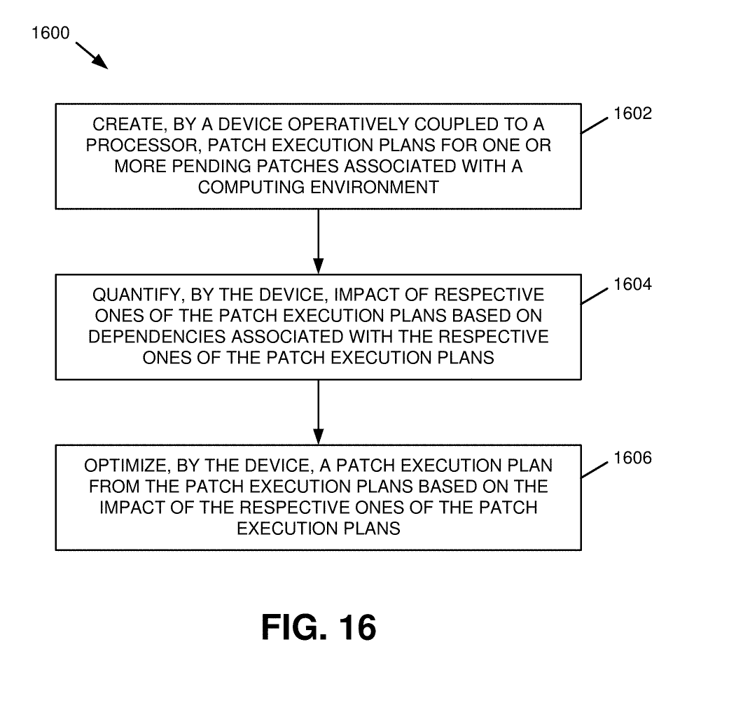

FIG. 16 illustrates a flow diagram of an example, non-limiting computer-implemented method 1600 that facilitates relational patch orchestration according to one or more embodiments described herein. Repetitive description of like elements employed in other embodiments described herein is omitted for sake of brevity.

At 1602, patch execution plans are created (e.g., by a planning component 310) for one or more pending patches associated with a computing environment (e.g., a computing environment 340) by a device operatively coupled to a processor (e.g., processor(s) 1410 of processing component 1400).

At 1604, the device quantifies (e.g., via a scoring component 320) impact of respective ones of the patch execution plans created at 1602 based on dependencies associated with the respective ones of the patch execution plans.

At 1606, the device optimizes (e.g., via a patch orchestration component 330) a patch execution plan from the patch execution plans created at 1602 based on the impact of the respective ones of the patch execution plans as quantified at 1604.

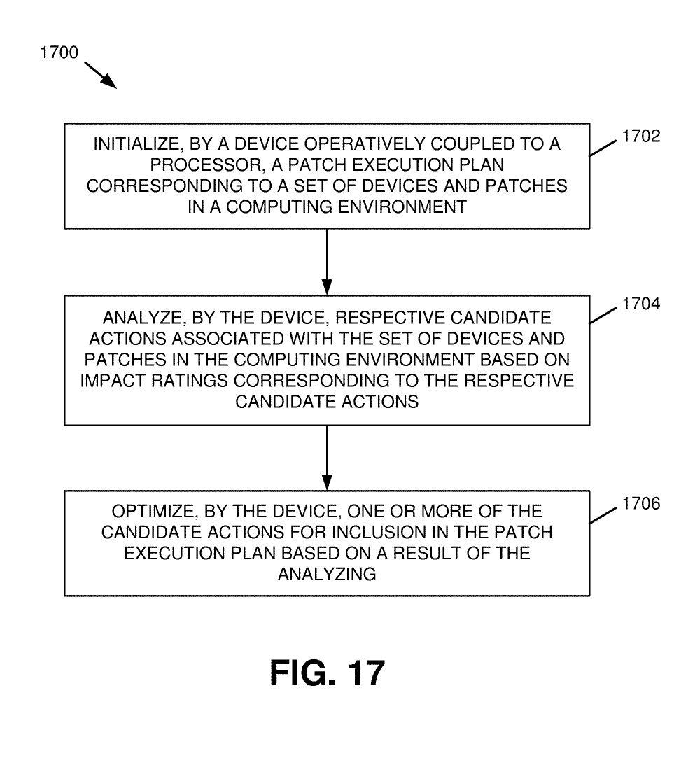

FIG. 17 illustrates a flow diagram of an alternative example, non-limiting computer-implemented method 1700 that facilitates relational patch orchestration according to one or more embodiments described herein. Repetitive description of like elements employed in other embodiments described herein is omitted for sake of brevity.

At 1702, a device operatively coupled to a processor (e.g., processor(s) 1510 of a processing component 1500) initializes (e.g., via a discovery component 1210) a patch execution plan corresponding to a set of devices and patches in a computing environment (e.g., computing environment 340).

At 1704, the device analyzes (e.g., via an impact analysis component 1220) respective candidate actions associated with the set of devices and patches in the computing environment based on impact ratings corresponding to the respective candidate actions.

At 1706, the device optimizes (e.g., via an action selection component 1230) one or more of the candidate actions for inclusion in the patch execution plan initialized at 1702 based on a result of the analyzing performed at 1704.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies can alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Moreover, because configuration of data packet(s) and/or communication between processing components and/or an assignment component is established from a combination of electrical and mechanical components and circuitry, a human is unable to replicate or perform the subject data packet configuration and/or the subject communication between processing components and/or an assignment component. For example, a human is unable to generate data for transmission over a wired network and/or a wireless network between processing components and/or an assignment component, etc. Moreover, a human is unable to packetize data that can include a sequence of bits corresponding to information generated during a spatial computing process, transmit data that can include a sequence of bits corresponding to information generated during a spatial computing process, etc.

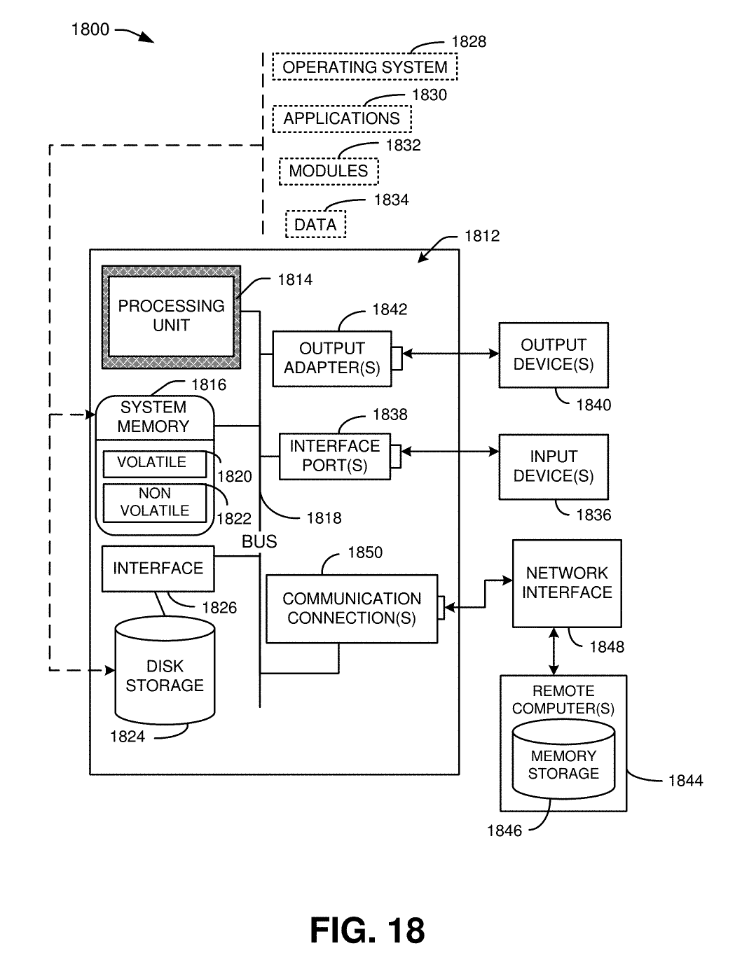

In order to provide a context for the various aspects of the disclosed subject matter, FIG. 18 as well as the following discussion are intended to provide a general description of a suitable environment in which the various aspects of the disclosed subject matter can be implemented. FIG. 18 illustrates a block diagram of an example, non-limiting operating environment in which one or more embodiments described herein can be facilitated. Repetitive description of like elements employed in other embodiments described herein is omitted for sake of brevity. With reference to FIG. 18, a suitable operating environment 1800 for implementing various aspects of this disclosure can also include a computer 1812. The computer 1812 can also include a processing unit 1814, a system memory 1816, and a system bus 1818. The system bus 1818 couples system components including, but not limited to, the system memory 1816 to the processing unit 1814. The processing unit 1814 can be any of various available processors. Dual microprocessors and other multiprocessor architectures also can be employed as the processing unit 1814. The system bus 1818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI). The system memory 1816 can also include volatile memory 1820 and nonvolatile memory 1822. The basic input/output system (BIOS), containing the basic routines to transfer information between elements within the computer 1812, such as during start-up, is stored in nonvolatile memory 1822. By way of illustration, and not limitation, nonvolatile memory 1822 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1820 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1812 can also include removable/non-removable, volatile/non-volatile computer storage media. FIG. 18 illustrates, for example, a disk storage 1824. Disk storage 1824 can also include, but is not limited to, devices like a magnetic disk drive, solid state drive, floppy disk drive, tape drive, Jaz drive, Zip drive, LS-100 drive, flash memory card, or memory stick. The disk storage 1824 also can include storage media separately or in combination with other storage media including, but not limited to, an optical disk drive such as a compact disk ROM device (CD-ROM), CD recordable drive (CD-R Drive), CD rewritable drive (CD-RW Drive), a digital versatile disk ROM drive (DVD-ROM), or a Blu-ray disc drive. To facilitate connection of the disk storage 1824 to the system bus 1818, a removable or non-removable interface is typically used, such as interface 1826. FIG. 18 also depicts software that acts as an intermediary between users and the basic computer resources described in the suitable operating environment 1800. Such software can also include, for example, an operating system 1828. Operating system 1828, which can be stored on disk storage 1824, acts to control and allocate resources of the computer 1812. System applications 1830 take advantage of the management of resources by operating system 1828 through program modules 1832 and program data 1834, e.g., stored either in system memory 1816 or on disk storage 1824. It is to be appreciated that this disclosure can be implemented with various operating systems or combinations of operating systems. A user enters commands or information into the computer 1812 through input device(s) 1836. Input devices 1836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1814 through the system bus 1818 via interface port(s) 1838. Interface port(s) 1838 include, for example, a serial port, a parallel port, a game port, and a universal serial bus (USB). Output device(s) 1840 use some of the same type of ports as input device(s) 1836. Thus, for example, a USB port can be used to provide input to computer 1812, and to output information from computer 1812 to an output device 1840. Output adapter 1842 is provided to illustrate that there are some output devices 1840 like monitors, speakers, and printers, among other output devices 1840, which require special adapters. The output adapters 1842 include, by way of illustration and not limitation, video and sound cards that provide a means of connection between the output device 1840 and the system bus 1818. It should be noted that other devices and/or systems of devices provide both input and output capabilities such as remote computer(s) 1844.

Computer 1812 can operate in a networked environment using logical connections to one or more remote computers, such as remote computer(s) 1844. The remote computer(s) 1844 can be a computer, a server, a router, a network PC, a workstation, a microprocessor based appliance, a peer device or other common network node and the like, and typically can also include many or all of the elements described relative to computer 1812. For purposes of brevity, only a memory storage device 1846 is illustrated with remote computer(s) 1844. Remote computer(s) 1844 is logically connected to computer 1812 through a network interface 1848 and then physically connected via communication connection 1850. Network interface 1848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1850 refers to the hardware/software employed to connect the network interface 1848 to the system bus 1818. While communication connection 1850 is shown for illustrative clarity inside computer 1812, it can also be external to computer 1812. The hardware/software for connection to the network interface 1848 can also include, for exemplary purposes only, internal and external technologies such as, modems including regular telephone grade modems, cable modems and DSL modems, ISDN adapters, and Ethernet cards.

Various embodiments of the present can be a system, a method, an apparatus and/or a computer program product at any possible technical detail level of integration. The computer program product can include a computer readable storage medium (or media) having computer readable program instructions thereon for causing a processor to carry out one or more aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of one or more embodiments of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform one or more aspects of the present invention.

One or more aspects of the present invention are described herein with reference to flowchart illustrations and/or block diagrams of methods, apparatus (systems), and computer program products according to one or more embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Various modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
creating, by a device operatively coupled to a processor, patch execution plans for one or more pending patches associated with a computing environment;
quantifying, by the device, an impact of respective ones of the patch execution plans based on dependencies associated with the respective ones of the patch execution plans; and
optimizing, by the device, a patch execution plan from the patch execution plans based on the impact of the respective ones of the patch execution plans.

2. The computer-implemented method of claim 1, wherein the dependencies comprise at least one of dependencies between respective patches associated with a patch execution plan, dependencies between respective computers in the computing environment, or dependencies between respective applications in the computing environment.

3. The computer-implemented method of claim 1, further comprising:
determining, by the device, respective risk factors associated with respective ones of the one or more pending patches, wherein the optimizing comprises optimizing the patch execution plan based on the respective risk factors.

4. The computer-implemented method of claim 1, wherein the optimizing comprises optimizing the patch execution plan based on historical data associated with at least one of the computing environment or respective ones of the one or more pending patches.

5. The computer-implemented method of claim 4, wherein the historical data comprises data relating to previously executed patches and respectively corresponding impact ratings, and wherein the quantifying comprises estimating the impact for the respective ones of the patch execution plans using respective ones of the impact ratings corresponding to the previously executed patches.

6. The computer-implemented method of claim 4, wherein the computer-implemented method further comprises:
storing, by the device, identities of respective patches associated with the patch execution plan and corresponding impact ratings for the respective patches with the historical data.

7. The computer-implemented method of claim 1, wherein the computing environment comprises a cloud computing environment.

8. A system comprising:
a memory that stores computer executable components; and
a processor that executes computer executable components stored in the memory, wherein the computer executable components comprise:
a planning component that creates patch execution plans for one or more pending patches associated with a computing environment;
a scoring component that quantifies impact of respective ones of the patch execution plans based on dependencies associated with the respective ones of the patch execution plans; and
a patch orchestration component that selects a patch execution plan from the patch execution plans based on the impact of the respective ones of the patch execution plans.

9. The system of claim 8, wherein the dependencies comprise at least one of dependencies between respective patches associated with a patch execution plan, dependencies between respective computers in the computing environment, or dependencies between respective applications in the computing environment.

10. The system of claim 8, wherein the scoring component comprises a risk assessment component that determines respective risk factors associated with respective ones of the one or more pending patches, and wherein the patch orchestration component selects the patch execution plan based on the respective risk factors.

11. The system of claim 8, wherein the patch orchestration component comprises a machine learning component that selects the patch execution plan based on historical data associated with at least one of the computing environment or respective ones of the one or more pending patches.

12. The system of claim 11, wherein the historical data comprises data relating to previously executed patches and respectively corresponding impact ratings, and wherein the quantifying comprises estimating the impact for the respective ones of the patch execution plans using respective ones of the impact ratings corresponding to the previously executed patches.

13. The system of claim 11, wherein the computer executable components further comprise:
an archival component that stores identities of respective patches associated with the patch execution plan selected by the patch orchestration component and corresponding impact ratings for the respective patches with the historical data.

14. A computer program product for patch orchestration in a computing environment, the computer program product comprising a computer readable storage medium having program instructions embodied therewith, the program instructions executable by a processor to cause the processor to:
create patch execution plans for one or more pending patches associated with the computing environment;
quantify an impact of respective ones of the patch execution plans based on dependencies associated with the respective ones of the patch execution plans; and
select a patch execution plan from the patch execution plans based on the impact of the respective ones of the patch execution plans.

15. The computer program product of claim 14, wherein the program instructions further cause the processor to:
determine respective risk factors associated with respective ones of the one or more pending patches; and
select the patch execution plan based on the respective risk factors.

16. The computer program product of claim 14, wherein the program instructions further cause the processor to:
select the patch execution plan based on historical data associated with at least one of the computing environment or respective ones of the one or more pending patches.

17. The computer program product of claim 16, wherein the historical data comprises data relating to previously executed patches and respectively corresponding impact ratings, and wherein the program instructions further cause the processor to:
estimate the impact for the respective ones of the patch execution plans using respective ones of the impact ratings corresponding to the previously executed patches.

18. A computer-implemented method comprising:
initializing, by a device operatively coupled to a processor, a patch execution plan corresponding to a set of devices and patches in a computing environment;
analyzing, by the device, respective candidate actions associated with the set of devices and patches in the computing environment based on impact ratings corresponding to the respective candidate actions; and
optimizing, by the device, one or more of the candidate actions for inclusion in the patch execution plan based on a result of the analyzing.

19. The computer-implemented method of claim 18, wherein the analyzing comprises analyzing the respective candidate actions based on historical data associated with at least one of the computing environment or the set of devices and patches in the computing environment.

20. The computer-implemented method of claim 19, further comprising:
executing, by the device, respective actions selected for inclusion in the patch execution plan, resulting in executed actions; and
recording, by the device, the executed actions and their corresponding outcomes in the historical data.

21. The computer-implemented method of claim 20, further comprising:
updating, by the device, the impact ratings for the respective actions selected for inclusion in the patch execution plan based on a result of the executing.

22. A system comprising:
a memory that stores computer executable components; and
a processor that executes computer executable components stored in the memory, wherein the computer executable components comprise:
a discovery component that identifies a set of devices and patches in a computing environment and initializes a corresponding patch execution plan;
an impact analysis component that analyzes respective candidate actions for the patch execution plan based on impact ratings corresponding to the respective candidate actions; and
an action selection component that selects one or more of the candidate actions for inclusion in the patch execution plan based on a result of the impact analysis component.

23. The system of claim 22, wherein the impact analysis component analyzes the respective candidate actions based on historical data associated with at least one of the computing environment or the set of devices and patches in the computing environment.

24. The system of claim 23, wherein the computer executable components further comprise:
a patch execution component that executes respective actions selected for inclusion in the patch execution plan, resulting in executed actions.

25. The system of claim 24, wherein the computer executable components further comprise:
a patch history component that records the executed actions and their corresponding outcomes in the historical data.
